(19) United States
(12) Patent Application Publication
(10) Pub. No.: US 2008/0049102 A1
(43) Pub. Date: Feb. 28, 2008

(54) MOTION DETECTION SYSTEM AND METHOD

(75) Inventors: Kyoung Soo Chae, Suwon (KR); Ghun Hahm, Seoul (KR); Hyun Joon Kim, Hwaseong (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/843,447

(22) Filed: Aug. 22, 2007

(30) Foreign Application Priority Data
Aug. 23, 2006 (KR) 10-2006-0079711

(51) Int. Cl. H04N 7/18

(52) U.S. Cl. 348/142; 348/E07.087

(57) ABSTRACT

Provided is a motion detection system for detecting a motion of a subject, the motion detection system including a detection unit that detects a three-axis straight motion and a three-axis rotating motion of the subject; a control unit that, when a motion is detected by the detection unit, analyzes the type of the detected motion and judges whether or not to transmit the analyzed motion to an observer terminal; a transmitting and receiving unit that transmits the analyzed motion to the observer terminal and receives a signal transmitted from the observer terminal; a sound device that detects sound from the subject and outputs a sound signal transmitted from the observer terminal; and a display unit that displays a power capacity and a setting state of the motion detection system.

### CROSS-REFERENCE TO RELATED APPLICATIONS

This application claims the benefit of Korean Patent Application No. 10-2006-0079711 filed with the Korea Intellectual Property Office on Aug. 23, 2006, the disclosure of which is incorporated herein by reference.

### BACKGROUND OF THE INVENTION

1. Field of the Invention

The present invention relates to a motion detection system and method, which can accurately detect a motion of a subject by using a three-axis straight motion detecting section and a three-axis rotating motion detecting section and then deliver the detected motion to an observer such that the observer can recognize the motion of the subject.

2. Description of the Related Art

In general, parents who bring up an infant or disabled person should observe the infant or disabled person at a close range, in order to protect the infant or disabled person from the surrounding danger.

When the parents manage the housework such as dish washing, laundering, cleaning or the like or go out before or while the infant or disabled person sleeps, they should observe if the infant or disabled person is exposed to danger or not. Therefore, they cannot manage their business normally.

To improve such inconvenience, Korea Patent Laid-Open Publication No. 2004-0106792 discloses an infant observing system and method. When parents are placed in such a situation that they cannot observe an infant, the system detects a tearful voice of the infant, photographs an image of the infant, and then transmits the image to the parents.

However, if the infant awakes from sleep or moves to another place to find the parents without crying after recognizing that the parents are not present around the infant, the infant observing system cannot detect it. Therefore, the state of the infant can be detected wrongly.

Further, when a tearful voice of the infant is detected, the system photographs an image of the infant to transmit to the parents. In this case, the parents should carry a separate display device which can display the photographed image such that the state of the infant is checked.

### SUMMARY OF THE INVENTION

An advantage of the present invention is that it provides a motion detection system and method, which can accurately detect a motion of a subject by using a three-axis straight motion detecting section and a three-axis rotating motion detecting section and then deliver the detected motion to an observer such that the observer can recognize the motion of the subject.

Additional aspects and advantages of the present general inventive concept will be set forth in part in the description which follows and, in part, will be obvious from the description, or may be learned by practice of the general inventive concept.

According to an aspect of the invention, a motion detection system for detecting a motion of a subject comprises a detection unit that detects a three-axis straight motion and a three-axis rotating motion of the subject; a control unit that, when a motion is detected by the detection unit, analyzes the type of the detected motion and judges whether or not to transmit the analyzed motion to an observer terminal; a transmitting and receiving unit that transmits the analyzed motion to the observer terminal and receives a signal transmitted from the observer terminal; a sound device that detects sound from the subject and outputs a sound signal transmitted from the observer terminal; and a display unit that displays a power capacity and a setting state of the motion detection system.

Preferably, the detection unit includes a straight-motion detecting section that detects the three-axis straight motion of the subject; and a rotating-motion detecting section that detects the three-axis rotating motion of the subject.

Preferably, the straight-motion detecting section serving as an acceleration sensor is any one of a capacitance sensor, a piezoresistive sensor, and a heat detection sensor. Further, the rotating-motion detecting section is a gyroscope or a geomagnetic sensor.

The motion detection system further comprises a Global Positioning System (GSP) unit that traces the position of the subject.

According to another aspect of the invention, a motion detection method for detecting a motion of a subject comprises a) detecting a three-axis straight motion and a three-axis rotating motion of the subject; b) analyzing the detected motion; c) determining whether or not to transmit the analyzed motion to an observer terminal; and d) when the transmitting of the analyzed motion is determined, transmitting the motion to an observer through wireless communication.

Preferably, the three-axis straight motion of the subject is detected using any one of a capacitance sensor, a piezoresistive sensor, and a heat detection sensor. Further, the three-axis rotating motion of the subject is detected using a gyroscope or a geomagnetic sensor.

The motion detection method further comprises tracing the position of the subject through a GPS.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a motion detection system according to a first embodiment of the invention;

FIG. 2 is a block diagram of a detection unit of the motion detection system;

FIG. 3 is a graph showing three axes of the detection unit of the motion detection system;

FIG. 4 is a block diagram schematically showing a motion detection system according to a second embodiment of the invention; and

FIG. 5 is a flow chart showing a motion detection method according to the invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, preferred embodiments of the present invention will be described in detail with reference to the accompanying drawings.

### First Embodiment

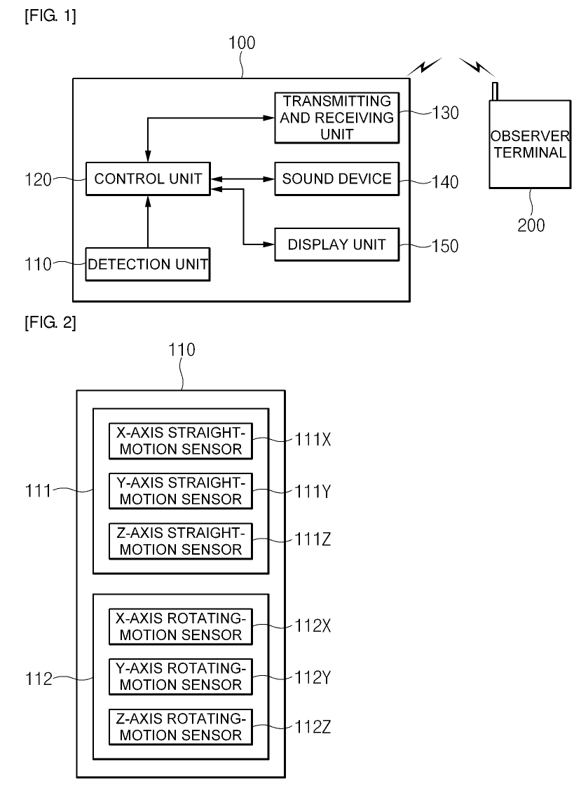

FIG. 1 is a schematic block diagram of a motion detection system according to a first embodiment of the invention. FIG. 2 is a block diagram of a detection unit of the motion detection system. FIG. 3 is a graph showing three axes of the detection unit of the motion detection system.

As shown in FIG. 1, the motion detection system according to the first embodiment of the invention includes a detection unit 110, a control unit 120, a transmitting and receiving unit 130, a sound device 140, and a display unit 150.

The detection unit 110, which is connected to the control unit 120, detects the motion of a subject as a three-axis straight motion and a three-axis rotating motion and then transmits the detected motion to the control unit 120.

As shown in FIG. 2, the detection unit 110 includes a straight-motion detecting section 111 which detects a straight motion of a subject and a rotating-motion detecting section 112 which detects a rotating motion of a subject.

The straight-motion detecting section 111 includes an X-axis straight-motion sensor 111 X, a Y-axis straight-motion sensor 111 Y, and a Z-axis straight-motion sensor 111Z. The straight-motion detecting section 111 detects in which direction a subject moves on the basis of the three axes, that is, an X axis, a Y axis, and a Z axis.

That is, as shown in FIG. 3, when a subject moves in an X-axis direction in a state where arbitrary X, Y, and Z axes are set, the X-axis straight-motion sensor 111X is driven to detect the motion and then converts the detected motion into an electric signal to deliver to the control unit 120. When a subject moves in the Y- or Z-axis direction, the straight-motion detecting section 111 operates in the same manner.

Preferably, the straight-motion detecting section 111 serving as an acceleration sensor is any one of a capacitance-type sensor, a piezoresistive sensor, and a heat detection sensor. The capacitance-type sensor includes two fixed plates (not shown) placed in parallel to each other and a movable plate (not shown) provided between the fixed plates. The movable plate moves in accordance with the motion of a subject so as to change the capacitance of the fixed plates. When a subject moves, the movable plate moves between the fixed plates so as to change capacitance proportional to the motion of the subject. Therefore, the capacitance-type sensor can convert the motion of the subject into an electrical signal. That is, the capacitance-type sensor can detect the straight motion of the subject.

The piezoresistive sensor includes an inertial mass provided therein. The inertial mass transmits an inertial force to the sensor through a motion perpendicular to the surface of the sensor, such that the sensor is physically deformed. At this time, a charge proportional to the deformation amount of the sensor is generated by a piezoelectric effect. The sensor determines acceleration through a quantity of the generated charge by using excellent linearity of the sensor. Therefore, the sensor can detect the straight motion of a subject.

The heat detection sensor converts a quantity of resistance variation into a voltage and converts a quantity of variation in heat distribution around the sensor into a voltage as an electrical signal, thereby detecting the straight motion of a subject.

The capacitance-type sensor, the piezoresistive sensor, and the heat detection sensor can be miniaturized by using a micro machine (MEMS) technology. Therefore, it is possible to reduce the size of the motion detection system 100.

The rotating-motion detecting section 112 includes an X-axis rotating-motion sensor 112X, a Y-axis rotating-motion sensor 112Y, and a Z-axis rotating-motion sensor 112Z. The rotating-motion detecting section 112 detects about which of X, Y, and Z axes a subject rotates.

That is, when the subject rotates about an X axis in a state where arbitrary X, Y, and Z axes are set, the X-axis rotating-motion sensor 112X is driven to detect that the subject rotates in an ‘h’ direction as shown in FIG. 3. The X-axis rotating-motion sensor 112 converts the detected motion into an electrical signal to deliver to the control unit 120.

Preferably, as for the rotating-motion detecting section 112, a gyroscope or a geomagnetic sensor is used. In the gyroscope, a metallic disk, which has a center axis and of which the edge overweighs the other portion, fixes the center of gravity, and the center axis can be rotated freely in any direction. Once the disk is rotated, it continuously rotates without changing a posture, while maintaining the direction of the center axis. Using such a characteristic, the sensor can detect about which axis a subject rotates.

In the geomagnetic sensor, a drive coil is wound along a circular ring core which is formed of a ferromagnetic material, and an X-coil (wound along the X axis) and a Y-coil (wound along the Y axis) are wound to cross the center of the ring core at right angles. When magnetic lines of force are generated in the ring core, a magnetic force generated in the ring core and an induction voltage synthesized with the geomagnetic field are measured through the X and Y coils, respectively. The sensor detects a direction by using a potential difference of the measured induction voltage. Therefore, the sensor can detect about which axis a subject rotates.

As described above, the straight-motion detecting section 111 serving as an acceleration sensor can detect the straight motion of a subject, and the rotating-motion detecting section 112 can detect the rotating motion of a subject.

The control unit 120 is connected to the detection unit 110, the transmitting and receiving unit 130, the sound device 140, and the display unit 150. When the motion of the subject is detected by the detection unit 110, the control unit 120 analyzes the type of the detected motion and judges whether or not to transmit the analyzed motion to an observer terminal 200.

For example, when it is assumed that the subject lies down to face upward, and if the subject turns left by 90 degrees to lie toward the side, the straight-motion detecting section 111 does not detect the motion of the subject, but the rotating-motion detecting section 112 detects a motion corresponding to the state where the subject turns left by 90 degrees. Then, the rotating-motion detecting section 112 converts the detected motion into an electrical signal to output.

Then, the control unit 120 receives the electrical signal output from the rotating-motion detecting section 112 and analyzes the motion through the electrical signal. Then, the control unit 120 recognizes that the subject, who had lied to face upward, turned left to lie toward the side. Further, the control unit 120 judges whether the motion of the subject is an unexpected motion in an emergency or a motion which can simply occur while the subject sleeps soundly. Then, the control unit 120 determines whether or not to inform an observer of the analyzed motion.

If the subject drops down from a bed while turning left to lie toward the side, the control unit 120 judges that help is needed for the subject. In this case, the control unit 120 delivers the state of the subject to the transmitting and receiving unit 130, in order to transmit the motion of the subject to an observer terminal 200 through wireless communication. When it is judged that the motion of the subject is a motion which can simply occur while the subject lies toward the side, the motion is ignored. Then, the detection unit 112 continuously performs detection.

The transmitting and receiving unit 130 connected to the control unit 120 receives the analyzed motion of the subject from the control unit 120 and then transmits the analyzed motion to the observer terminal 200.

Since the information transmitted through the observer terminal 200 is received as a text or sound, the observer can check the state of the subject. Therefore, although a separate device for displaying a photographed image is not provided, the observer can check the information through the observer terminal 200.

Further, the observer transmits a sound to the transmitting and receiving unit 130 through the observer terminal 200.

Then, the transmitting and receiving unit 130 transmits the sound, transmitted through the observer terminal 200, to the control unit 120. Further, the control unit 120 delivers the transmitted sound to the sound device 140.

The sound device 140 outputs the sound delivered from the control unit 120 to the outside such that the subject can hear the output sound. Then, the subject can take a necessary action. Further, the subject can deliver a sound to the observer by using the sound device 140.

The display unit 150 displays a power capacity and the setting state of the motion detection system 100 such that the setting for the motion of a subject can be changed. Further, the display unit 150 informs the observer of a replacement time of battery.

Accordingly, when the subject moves straightly or turns left or right, the observer can easily recognize the state of the motion through the motion detection system 100. Then, the observer can protect the subject through a simple instruction.

Further, since the detection unit 110 can be miniaturized through the MEMS technology, it is possible to reduce the size of the motion detection system 100.

### Second Embodiment

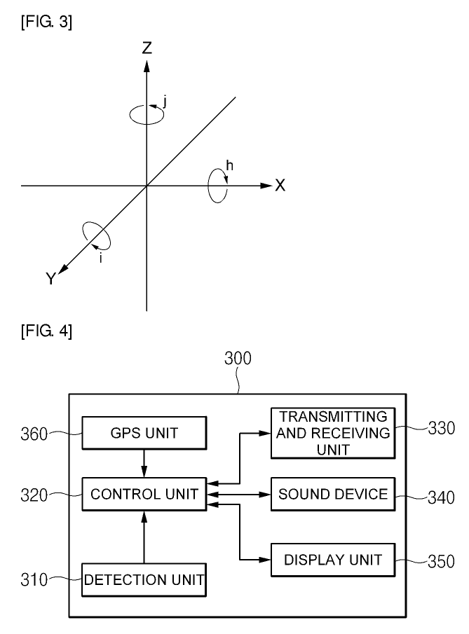

FIG. 4 is a block diagram schematically showing a motion detection system according to a second embodiment of the invention. The descriptions of the same construction as that of the first embodiment will be omitted.

As shown in FIG. 4, the motion detection system 300 according to the second embodiment of the invention includes a detection unit 310, a control unit 320, a transmitting unit 330, a sound device 340, a display unit 350, and a Global Positioning System (GPS) unit 360.

The GPS used in the GPS unit 360 is a system developed by US Department of Defense. In the GPS, a GPS reception module receives navigation information transmitted from a GPS satellite, and the position of the GPS reception module can be calculated as a three-dimensional coordinate by using the received navigation information. Therefore, the position of the GPS reception module can be accurately found anywhere in the whole world, through the navigation information of the GPS satellite.

The GPS unit 360 having the GPS reception module provided therein can be mounted in the motion detection system 300 so as to accurately trace the position of a subject.

For example, when it is assumed that a subject is an infant who cannot walk or run by itself, and if the straight motion of the infant is accelerated, it can be judged that the infant is moved by somebody without an approval of an observer. At this time, the observer can easily recognize the position and movement speed of the infant through the GPS unit 360. Accordingly, the observer can easily find the infant.

As described above, since the movement and position of the subject can be accurately recognized through the GPS unit 360 of the motion detection system 300, the observer can protect and observe the subject.

Now, a motion detection method according to the invention will be described with reference to the accompanying drawings.

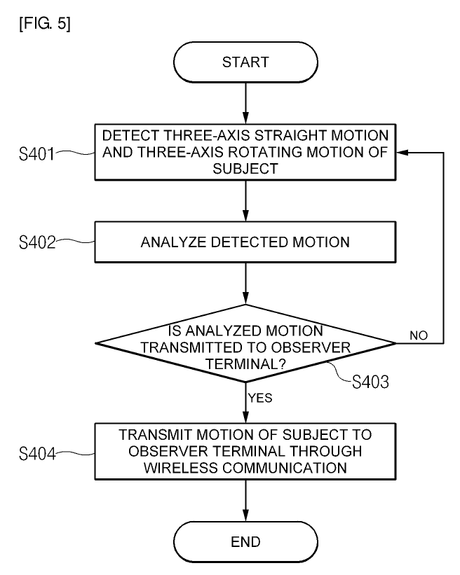

FIG. 5 is a flow chart showing a motion detection method according to the invention.

First, as shown in FIG. 5, a three-axis straight motion and a three-axis rotating motion of a subject are detected (step S401).

Then, when the motion of the subject is detected at step S401, the detected motion is analyzed (step S402).

Next, it is judged whether the analyzed motion is an unexpected motion in an emergency or a motion which can generally occur, and it is determined whether or not to transmit the analyzed motion to an observer (step S403).

At this time, when it is judged that the analyzed motion is a motion which can generally occur, the analyzed motion does not need to be transmitted to an observer. In this case, the motion of the subject is continuously detected.

If it is judged that the analyzed motion is such an unexpected motion that help is needed for the subject, the analyzed motion is transmitted to the observer terminal through wireless communication, in order to inform the observer of that (step S404).

Further, when the subject is quickly moved without an approval of the observer, the position of the subject can be traced through the GPS.

Accordingly, even when the subject is not present around the observer, the observer can check the state of the subject through the motion detection method. Therefore, the observer can manage a personal business without anxiety.

According to the motion detection system and method of the invention, the motion of the subject is accurately detected by the straight-motion detecting section and the rotating-motion detecting section mounted on the detection unit and is then transmitted to the observer. Therefore, the motion of the subject can be detected.

Further, when the subject is moved somewhere without an approval of the observer, the position of the subject can be accurately found by the GPS unit. Therefore, the subject can be effectively observed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A motion detection system for detecting a motion of a subject, the motion detection system comprising:
a detection unit that detects a three-axis straight motion and a three-axis rotating motion of the subject;
a control unit that, when a motion is detected by the detection unit, analyzes the type of the detected motion and judges whether or not to transmit the analyzed motion to an observer terminal;
a transmitting and receiving unit that transmits the analyzed motion to the observer terminal and receives a signal transmitted from the observer terminal;
a sound device that detects sound from the subject and outputs a sound signal transmitted from the observer terminal; and
a display unit that displays a power capacity and a setting state of the motion detection system.

2. The motion detection system according to claim 1,
wherein the detection unit includes:
a straight-motion detecting section that detects the three-axis straight motion of the subject; and
a rotating-motion detecting section that detects the three-axis rotating motion of the subject.

3. The motion detection system according to claim 2,
wherein the straight-motion detecting section serving as an acceleration sensor is any one of a capacitance sensor, a piezoresistive sensor, and a heat detection sensor.

4. The motion detection system according to claim 2,
wherein the rotating-motion detecting section is a gyroscope or a geomagnetic sensor.

5. The motion detection system according to claim 1 further comprising:
a Global Positioning System (GSP) unit that traces the position of the subject.

6. A motion detection method for detecting a motion of a subject, the motion detection method comprising:
a) detecting a three-axis straight motion and a three-axis rotating motion of the subject;
b) analyzing the detected motion;
c) determining whether or not to transmit the analyzed motion to an observer terminal; and
d) when the transmitting of the analyzed motion is determined, transmitting the motion to an observer through wireless communication.

7. The motion detection method according to claim 6,
wherein the three-axis straight motion of the subject is detected using any one of a capacitance sensor, a piezoresistive sensor, and a heat detection sensor.

8. The motion detection method according to claim 6,
wherein the three-axis rotating motion of the subject is detected using a gyroscope or a geomagnetic sensor.

9. The motion detection method according to claim 6 further comprising:
tracing the position of the subject through a GPS.
